(19) United States
(12) Patent Application Publication
(10) Pub. No.: US 2015/0199723 A1
(43) Pub. Date: Jul. 16, 2015

(54) SYSTEM AND METHOD FOR PROCURING A LOCAL SERVICE PROVIDER

(71) Applicant: Daniel Petrean, Skokie, IL (US)

(72) Inventor: Daniel Petrean, Skokie, IL (US)

(21) Appl. No.: 14/594,591

(22) Filed: Jan. 12, 2015

Related U.S. Application Data
(60) Provisional application No. 61/926,606, filed on Jan. 13, 2014.

(51) Int. Cl. G06Q 30/02

(52) U.S. Cl. CPC G06Q 30/0261; G06Q 30/0256; G06Q 30/0267

(57) ABSTRACT

System and method locate and/or procure a local service provider using a mobile device. The system has mobile devices connected to a network. The mobile devices have GPS and/or touch screens. Contractors and/or consumers register for and/or use an application to allow the consumers to find local contractors using GPS location of the contractors. The system has a contractor interface and a consumer interface. The method allows contractors to register, select a subscription plan and create a profile. Consumers search for local contractors using GPS or zip code information. The method allows consumers to select the closest contractor and/or review the contractor profile. Consumers communicate with the contractors using the application. Consumers review and/or rate the contractors. Consumers locate contractors, contractors locate other contractors, contractors locate subcontractors and/or contractors locate consumers using the system and/or the method.

### CROSS-REFERENCE TO RELATED APPLICATIONS

This application claims the benefit of U.S. Provisional Patent Application No. 61/926,606, filed Jan. 13, 2014, the disclosure of which is incorporated herein by reference.

### BACKGROUND OF THE INVENTION

The present invention relates to locating a service provider and more specifically, to a system and/or a method for procuring a local service provider.

Millions of people engage in commerce everyday in a large variety of projects and/or businesses in which service providers are needed. However, many times the process of locating and/or obtaining a service provider may be complicated and/or difficult. For example, the breadth of services desired may be varied in number and/or type. A consumer may be looking for a building contractor to remodel a bathroom, kitchen or even build an addition to a property. To accomplish such a project, the consumer may require several different trades. The project may require service providers and/or contractors in the fields of construction, drywall, plumbing, electrical, heating, ventilation and air conditioning (“HVAC”), flooring, painting, windows, doors, millwork and/or the like.

Alternatively, the consumer may search for a general contractor who may locate and/or hire most or all of the subcontractors specializing in the various trades needed. Typically, general contractors may have an established group of subcontractors and/or service providers in the various trades that may be used for projects obtained by the general contractor.

However, many times a particular subcontractor and/or service provider may be unavailable for a certain project, and the general contractor may require a replacement for the usual subcontractor. Also, certain projects may require a certain specialty that may be beyond or outside of the capabilities of the subcontractor and/or service provider.

Subcontractors and/or service providers may also fail to arrive at the project site in a timely and/or regular manner. Also, the subcontractor and/or service provider may fail to perform adequately or properly. Such incidents frequently occur for various reasons. For example, certain projects may extend beyond the original timelines which may cause a ripple effect on other concurrently scheduled jobs and/or subsequently scheduled projects. On such occasions, numerous projects may fall behind when a service provider fails to perform as needed and/or on time.

Thus, a contractor may be required to find a replacement subcontractor and/or service provider to fill a vacancy and/or a specific trade. The contractor may require a subcontractor, for example, when a subcontractor abandons a job, and the contractor may hire a replacement to remain on schedule and/or complete the project.

In addition to locating the desired contractors and/or service providers in the necessary trades, the consumer may encounter difficulties in securing the contractors and/or service providers in the immediate area of the project. Local contractors and/or service providers in the same region may be more reliable due to their close proximity to the project site. Such local contractors and/or service providers may also be more familiar with local building codes and/or may have better local contacts for suppliers for materials needed for the project. Further, local contractors and/or service providers in the same area as the project may be more concerned about their reputation. As a result, the local contractors and/or service providers may perform to a higher level to retain customers. Satisfied customers may become repeat customers. Further, such high performing local contractors and/or service providers may enjoy more referrals from satisfied customers.

Even when the consumer may be able to locate local contractors and/or service providers that fulfill the requirements for the necessary trades, the contractors and/or service providers may not be available to start work on the project as desired. Some projects may not be able to secure the needed service providers when needed and/or as desired due to scheduling conflicts and/or the like.

Another common problem in locating and/or procuring a contractor for a certain project in a particular area may be finding a database and/or collection of contractors and/or related contact information. For example, telephone directories may be outdated and/or may not define the work areas and/or locales with enough specificity. Also, perusing a telephone directory has become a rather antiquated manner of searching for and/or researching information about a service provider. In fact, many people do not have a telephone directory and/or may not even have a home telephone. Internet searching may be more useful than a telephone directory but may also have some limitations related to pinpointing the work region for a particular contractor and/or service provider. Also, the availability of the contractor and/or service provider may not be provided and/or may not be evident from the internet information available.

Contractors and/or service providers may also want to locate local customers in the area. Potential customers may advertise for help wanted so the local contractor and/or service provider may contact the customer directly to offer the services desired.

A need, therefore, exists for a system and/or a method which may be used to locate and/or procure a local service provider. Also, a need exists for a system and/or a method which may use a mobile device to locate and/or procure a local service provider. Further, a need exists for a system and/or a method which may use a mobile device to determine immediate availability and/or proximate location of a local service provider. Moreover, a need exists for a system and/or a method which may use a mobile device to provide contractors and/or service providers with the location of a potential consumer requiring a service.

### SUMMARY OF THE INVENTION

The present invention relates to a system and/or a method which may be used to locate and/or procure a local service provider using a mobile device and an application.

To this end, in an embodiment, a system for procuring desired contracting services from a contractor located within a region determined by a customer is provided. The system may have a network and a first mobile device connected to the network. The first mobile device may have location detection that may provide a current location of the customer. The customer may input a query for the desired contracting services on the first mobile device. A second mobile device may be connected to the network. The second mobile device may have location detection that provides a current location of the contractor in the region. A database may be connected to the network. The database may have a contractor profile with information related to the contractor and information related to contracting services offered by the contractor. The contractor may use the second mobile device to input the contractor profile into the database. An application on the first mobile device and the second mobile device may process the query to locate the contractor in the region by using the current location of the contractor and the current location of the customer. The application may provide the contractor profile from the database to the first mobile device in response to the query.

In an embodiment, the location detection may use a global positioning system.

In an embodiment, the application may have a contractor interface in the application. The contractor may input information using the second mobile device. The information may be related to the contractor profile.

In an embodiment, the application may have a customer interface. The customer may input information using the first mobile device. The information may be related to the query.

In an embodiment, the application may have an administrator interface. An administrator may provide information related to the application to users of the application. The information may be received by the first mobile device and the second mobile device.

In another embodiment, a method for procuring a desired contracting service from a contractor located within a region selected by a customer is provided. The method may have the steps of: providing an application on a network wherein the application may have a customer interface and a contractor interface; connecting a first mobile device having a screen and a second mobile device having a screen to the network wherein the application may be on the first mobile device and the second mobile device and further wherein the first mobile device may be associated with the customer and the second mobile device may be associated with the contractor; inputting a contractor profile having information related to the contractor and information related to contracting services offered by the contractor into a database connected to the network wherein the contractor may use the contractor interface of the application on the second mobile device to input the contractor profile into the database; submitting a request for the desired contracting service wherein the customer may use the customer interface of the application on the first mobile device to submit the request; detecting a current location of the customer and a current location of the contractor within the region; locating the contractor in the region using the application in response to the request by the customer on the customer interface wherein the application may use the current location of the customer and the current location of the contractor; and providing the contractor profile of the contractor to the customer on the customer interface of the first mobile device.

In an embodiment, a search may be performed for the desired contracting service using the customer interface. The search may use postal code information associated with the region.

In an embodiment, a search may be performed for the desired contracting service using the customer interface. Current locations of a plurality of contractors may be shown on the screen of the first mobile device.

In an embodiment, the customer and the contractor may communicate. The customer may use the customer interface to contact the contractor.

In an embodiment, the contractor interface of the application may be used to indicate a status of the contractor. The status may relate to availability of the contractor.

In an embodiment, a customer review of the contractor may be provided using the customer interface.

In an embodiment, the current location of the contractor may be provided on the screen of the first mobile device.

In an embodiment, a contractor profile display may be provided on the screen of the first mobile device. The contractor profile display may have a plurality of icons. The customer may select one of: a telephone icon related to a telephone number of the contractor, a text messaging icon related to a texting address of the contractor, a social media link icon related to the social media address of the contractor and a contractor website link icon related to a web address for a website of the contractor.

In an embodiment, a distance between the current location of the customer and the current location of the contractor may be calculated.

In an embodiment, the customer may be redirected to a contractor profile in response to an input on the customer interface.

In an embodiment, customers may be located in response to a search by the contractor using the application on the second mobile device. The current location of the customers may be displayed on the screen of the second mobile device.

In an embodiment, a subcontractor may be located in response to a search by the contractor using the application on the second mobile device. A current location of the subcontractor may be displayed on the screen of the second mobile device.

In an embodiment, the contractor may manage the contractor profile by inputting information related to registration for the application on the second mobile device.

In an embodiment, payments for registration to use the application may be made using the contractor interface.

In an embodiment, information may be sent to users of the application. The information may be at least one of: an alert, an application version update, an advertisement and administrative information.

It is, therefore, an advantage of the present invention to provide a system and/or a method to locate and/or procure a local service provider.

Another advantage of the present invention is to provide a system and/or a method to locate and/or procure a local service provider using a mobile device.

Yet another advantage of the present invention is to provide a system and/or a method which may use a mobile device to determine the live and/or real-time location of a local service provider for providing the current location of the local service provider to the user.

A further advantage of the present invention is to provide a system and/or a method to locate and/or procure a local service provider which may provide information about the services provided by the local service provider.

Another advantage of the present invention is to provide a system and/or a method to locate and/or procure a local service provider which may provide information about the immediate availability of the local service provider.

Yet another advantage of the present invention is to provide a system and/or a method to locate and/or procure a local service provider which may provide a quick response from a local service provider in case of an emergency.

An advantage of the present invention is to provide a system and/or a method to locate and/or procure a local service provider in which the consumer may use the system 10 for periodic services, one-time services and/or emergency services.

A still further advantage of the present invention is to provide a system and/or a method to locate and/or procure a local service provider which may be operated by a contractor or a consumer.

A further advantage of the present invention is to provide a system and/or a method to locate and/or procure a local service provider which is capable of locating a contractor and/or service provider of any type.

An advantage of the present invention is to provide a system and/or a method to locate and/or procure a local service provider which may provide reviews and/or ratings of the local service provider.

Another advantage of the present invention is to a system and/or a method to locate and/or procure a local service provider in which information is continuously updated to provide real-time locations and information.

Yet another advantage of the present invention is to provide a system and/or a method to locate and/or procure a local service provider which may provide analytic information and/or data for the local service provider.

Still another advantage of the present invention is to provide a system and/or a method to locate and/or procure a local service provider which may allow the local service provider to change and/or update information related to services provided and/or current location information.

A further advantage of the present invention is to provide a system and/or a method to locate and/or procure a local service provider which may use GPS to determine the current location of the local service provider and/or the user in real-time.

Moreover, an advantage of the present invention is to provide a system and/or a method to locate and/or procure a local service provider which may use zip code information to determine the location of the local service provider and/or the user.

An advantage of the present invention is to provide a system and/or a method to locate and/or procure a local service provider which may provide advertising and/or marketing information.

Another advantage of the present invention is to provide a system and/or a method to locate and/or procure a local service provider which is portable.

Yet another advantage of the present invention is to provide a system and/or a method to locate and/or procure a local service provider which may be operated by a contractor to locate and/or procure a local service provider.

Still further, an advantage of the present invention is to provide a system and/or a method to locate and/or procure a local service provider which is inexpensive.

An advantage of the present invention is to provide a system and/or a method to locate and/or procure a local service provider which is simple to use.

Another advantage of the present invention is to provide a system and/or a method to locate and/or procure a local service provider which may allow communications between users and the local service provider.

A further advantage of the present invention is to provide a system and/or a method to locate and/or procure a local service provider which may allow communications related to the system to be sent to the users.

Yet another advantage of the present invention is to provide a system and/or a method to locate and/or procure a local service provider that may provide contracting, construction, home building, additions, handyman services, drywall, plumbing, electrical, heating, ventilation and air conditioning (“HVAC”), roofing, concrete, flooring, painting, windows, doors, millwork, carpet cleaning, locksmith, cleaning, appliance repair, computer repair, chimney cleaning, automobile and/or truck towing, auto glass, landscaping, auto repair, garage door, bathroom remodeling, kitchen remodeling, basement remodeling, siding installation, gutter cleaning, painting, decorating, dry cleaning, pet treatment and/or storage, duct cleaning, insulation, house inspections, demolition, window cleaning, tile installation and/or cleaning, low voltage electrical, refinishing floors, refinishing cabinets, molding installation, upholstery cleaning and/or refurbishing, window treatments, brickwork, pavement, brick and/or stone installation, fireplace installation, stucco installation, fence installation, deck building, escape window installation, basement crack sealing, mold and/or mildew removal, bath tub and/or shower refurbishing, pest control services, termite treatment, tree trimming and/or removal, real estate services, carpet tiles installation, wood framing, metal framing, snow removal, plaster services, stair installation, mosaic refinishing, pool repair and/or installation, pool cleaning, closet organizer, foundation installation, junk removal, demolition, dirt removal, moving and/or storage, store front building, medical equipment installation, tuck pointing, irrigation installation, in-floor heating, concrete heating, house cleaning, babysitting, septic tank cleaning, security systems, glass services, sunroom construction, and/or flower delivery and/or the like.

Additional features and/or advantages of the present invention are described in, and will be apparent from, the detailed description of the presently preferred embodiments and from the drawings.

### BRIEF DESCRIPTION OF THE DRAWINGS

FIG. 1 is a schematic view of a system in accordance with embodiments of the present invention.

FIG. 2 is a flowchart of a system in accordance with an embodiment of the present invention.

FIG. 3 is a front view of an embodiment of a splash display on a screen in accordance with the system of the present invention.

FIG. 4 is a front view of an embodiment of a contractor interface display on the screen in accordance with the system of the present invention.

FIG. 5 is a front view of an embodiment of a registration, subscription and/or profile creation display on the screen in accordance with the system of the present invention.

FIG. 6 is a front view of an embodiment of a contractor profile display on the screen in accordance with the system of the present invention.

FIG. 7 is a front view of an embodiment of a main contractor display on the screen in accordance with the system of the present invention.

FIG. 8 is a front view of an embodiment of a contractor locating map display on the screen in accordance with the system of the present invention.

FIG. 9 is a front view of an embodiment of an administration panel display on the screen in accordance with the system of the present invention.

FIG. 10 is a front view of an embodiment of a push notification display on the screen in accordance with the system of the present invention.

FIG. 11 is a front view of an embodiment of an advertising display on the screen in accordance with the system of the present invention.

FIG. 12 is a front view of another embodiment of a contractor locating map display on the screen in accordance with the system of the present invention.

FIG. 13 is a front view of an embodiment of a user locating map display on the screen in accordance with the system of the present invention.

### DETAILED DESCRIPTION OF THE PRESENTLY PREFERRED EMBODIMENTS

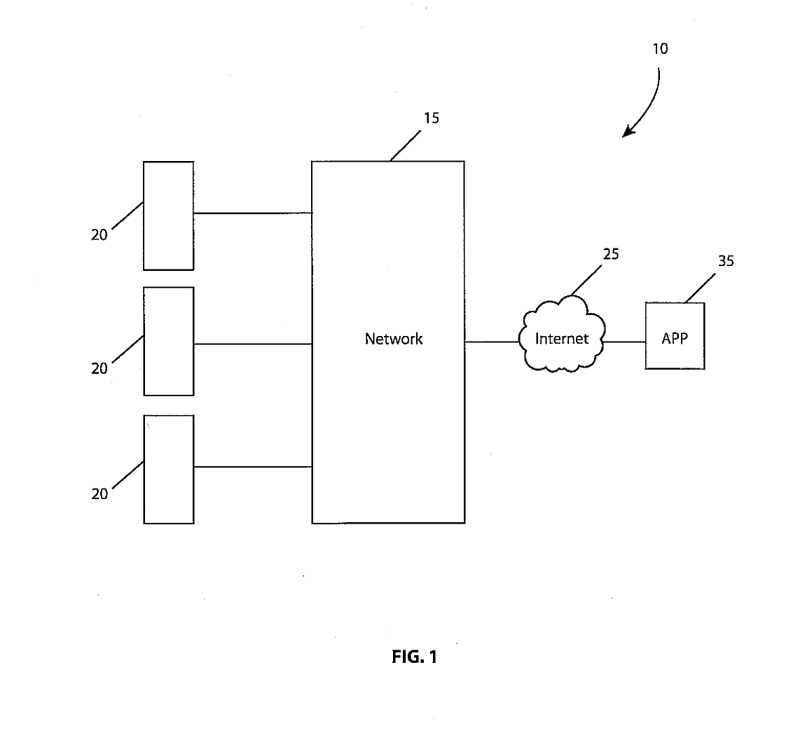

The present invention relates to a system and/or a method for locating and/or procuring a local service provider. Referring now to the drawings, wherein like numerals refer to like parts, FIG. 1 illustrates an embodiment of a system 10 for locating and/or procuring a local service provider and/or a contractor. Thus, the system 10 may be used by a consumer to locate and/or procure a local service provider. Also, the system 10 may be used by a consumer to locate and/or procure a contractor. Further, the system 10 may be used by a contractor to locate and/or procure another contractor. In addition, the system 10 may be used by a contractor to locate and/or procure a subcontractor. Moreover, the system 10 may be used by a contractor to locate a consumer in need of a service.

In an embodiment, service providers and/or contractors of all different types and/or services may be located and/or procured using the system 10 and/or method of the present invention. For example, the system 10 and/or method of the present invention may be used to locate and/or procure a local service provider that may provide contracting, construction, drywall, plumbing, electrical, heating, ventilation and air conditioning (“HVAC”), roofing, concrete, flooring, painting, windows, doors, millwork, carpet cleaning, locksmith, cleaning, appliance repair, computer repair, chimney cleaning, towing, auto glass, landscaping, auto repair, handyman services and/or the like.

Referring to FIG. 1, an embodiment of the system 10 of the present invention is illustrated. In the embodiment, the system 10 may have a network 15. For example, the network 15 may be suitable for use with a mobile device 20. The mobile device 20 may be used by contractors, service providers and/or subcontractors. Further, the mobile device 20 may be used by individual private consumers and/or business users. The mobile device 20 may be wirelessly connected to the network 15. The user of the mobile device 20 may have a subscription to obtain communication services on the network 15. The network 15 may be connected to the internet 25. The internet 25 may provide a variety of applications 35 and/or other capabilities for use with the mobile device 20 and/or the network 15.

In an embodiment, the mobile device 20 may be cellular telephones, smartphones, tablets, notebooks and/or the like. The mobile device 20 may have an operating system. For example, the operating system may be iOS® (a registered trademark of Apple, Inc.), Android® (a registered trademark of Google, Inc.), Windows® (a registered trademark of Microsoft Corporation) or any other operating system for use on the mobile device 20. The present invention is not limited to a particular operating system. Any suitable operating system may be considered to be within the scope of the present invention. In the illustrated embodiment of the present invention shown in FIG. 1, three mobile devices 20 are shown connected to the network 15. Of course, the network 15 may be capable of supporting a much larger number of mobile devices 20.

In an embodiment, the mobile device 20 may be cellular telephones, smartphones, tablets, notebooks and/or the like. The mobile device 20 may have several features and/or capabilities. For example, the mobile device 20 may have global positioning system (“GPS”) capabilities. Thus, the real-time location of the mobile device 20 may be determined by using the GPS capabilities of the mobile device 20. As a result, the real-time location of the corresponding user of each mobile device 20 may be determined by using the GPS capabilities of the mobile device 20.

The mobile device 20 may have other features and/or capabilities. For example, the mobile device 20 may have touchscreen capabilities. Thus, the user may operate the mobile device 20 by providing inputs via a screen 30 on the mobile device 20. The screen 30 may also be used by the user to view information and/or make selections during operation of the system 10 and/or the method of the present invention.

FIG. 2 illustrates a flowchart of the system 10 and/or a method for locating and/or procuring a contractor, subcontractor and/or local service provider in accordance with an embodiment of the present invention. The flowchart illustrates the flow of the application 35 that may operate on the mobile device 20 and/or the network 15. The flowchart indicates the particular steps involved in using the system 10 and/or a method for locating and/or procuring a contractor, subcontractor and/or local service provider.

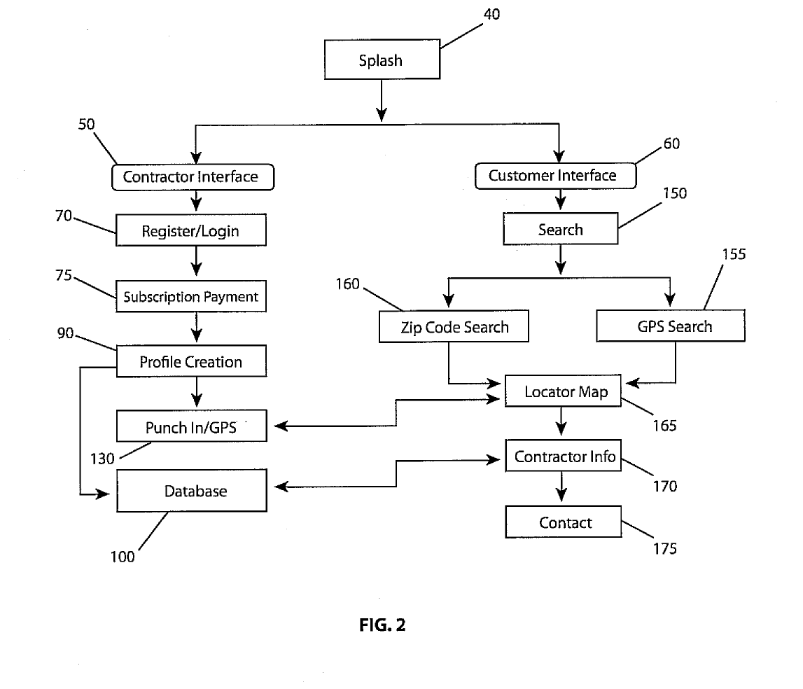

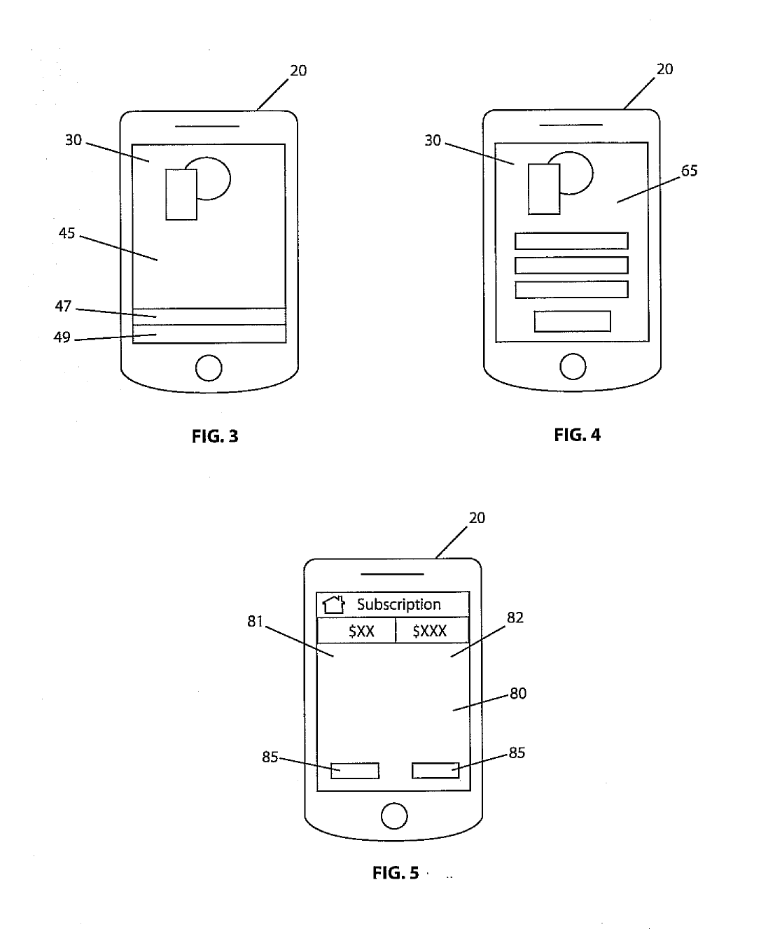

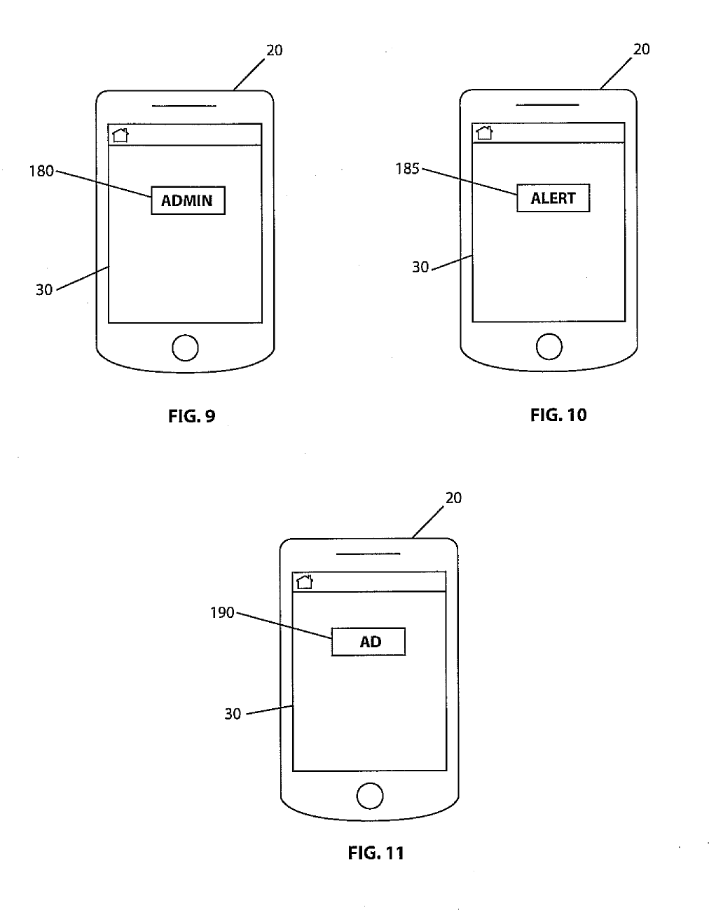

In addition, FIGS. 3-13 illustrate examples of various displays on the screen 30 of the mobile device 20. The screen 30 may display information for the user to view and/or select during various operations of the system 10 and/or the method. The user may provide inputs directly on the screen 30.

In an embodiment, the user may use the mobile device 20 and/or the network 15 and/or the internet 25 to locate the application 35. For example, the application 35 may be located by searching the internet 25 using the mobile device 20. The application 35 may be used by contractors and/or consumers who are looking to hire a contractor. Thus, the application 35 may have separate interfaces for the contractors and the consumers.

Consumers may use the application 35 to locate contractors in the local area of the consumer. The closest contractors to the consumers may be located using GPS features of the mobile device 20 and/or the application 35. Alternatively, zip code information may be used to locate contractors in the local area of the consumer. The consumers may also be able to view a profile of a particular contractor using the application 35. Further, the consumer may be able to obtain the contact information of the contractor using the application 35.

Contractors may be users of the system 10 and/or the method of the present invention. Contractors may require local subcontractors to bid on projects, to secure projects and/or to work on projects. Contractors may also require replacement subcontractors when the initial subcontractors hired may leave a project for various reasons. Contractors may also use the application 35 to locate another contractor and/or to find subcontractors in the local area of the contractor and/or the consumer. The closest contractors and/or subcontractors to the contractor may be located using GPS features of the mobile device 20 and/or the application 35.

Contractors may use the application 35 to sign up, register and/or subscribe to a contractor locating service. The contractors may build a profile. The profile may have contact information, a listing of services offered by the contractor and/or any other marketing or other information desired. The contractor may also activate features of the application 35 to provide the live, real-time location of the contractor. Moreover, the contractor may indicate availability status by using the application 35.

The application 35 may provide a platform for contractors to advertise their services to consumers. As a result, the application may connect consumers with local contractors offering the particular service desired. Using the GPS and/or zip code location features of the application 35 may enable the user to locate and/or procure the closest contractor for the project.

The system 10 and/or the method of the present invention may be described by referring to the flowchart of FIG. 2 in conjunction with reference to the displays on the screens 30 shown on FIGS. 3-13. The flowchart of FIG. 2 illustrates the steps of the method of the present invention. For example, the user may first download the application 35 onto the mobile device 20. The application 35 that may operate in accordance with the system 10 and/or the method for locating and/or procuring a contractor, subcontractor and/or local service provider of the present invention.

As shown in FIG. 2, the method of the present invention may have step 40. Upon downloading the application 35 onto the mobile device 20, step 40 may open/or initiate the application 35 by providing a splash display 45 on the screen 30. FIG. 3 illustrates an example of the splash display 45 on the screen 30 of the mobile device 20. The splash display 45 may have initial information for the user to view before advancing to the next display on the screen 30.

On the splash display 45, the user may be asked to indicate whether the user is a contractor or a customer. The user may do so by providing an appropriate touch input on the screen 30. For example, if the user is a customer, the user may touch the portion of the screen 30 where the splash display 45 has a tab 47 stating “I am looking for a contractor”.

Alternatively, if the user is a contractor, the user may touch the portion of the screen 30 where the splash display 45 has a tab 49 stating “I am a contractor”. After touching the desired tab on the splash display 45, the user may be directed to another screen display responsive to the selection made by the user. For example, the flowchart of FIG. 2 indicates contractor interface 50 and a customer interface 60. The user may be directed to the appropriate interface corresponding to the prior user input indicating whether the user is a consumer or a contractor.

In an embodiment, the contractor interface 50 may have a contractor interface display 65. The contractor interface display 65 is illustrated in FIG. 4. The contractor interface display 65 may allow the contractor to perform certain functions within the application 35. As shown in the flowchart of FIG. 2, step 70 of the contractor interface 50 of the application 35 may allow the contractor to register and/or log in to the application 35.

Step 75 of the contractor interface 50 of the application 35 may allow the contractor to subscribe to the application 35 by selecting a subscription plan and making an appropriate payment. For example, first-time contractor users of the application 35 may be directed to a registration, subscription and/or profile creation display 80 on the screen 30 as shown in FIG. 5. The contractor may provide basic information on a registration form to create an account in the application 35.

After an account is created for the contractor, the contractor may review and/or select a subscription plan on the registration, subscription and/or profile creation display 80 of the application 35. The subscription plans may be daily, weekly, monthly, quarterly or annually. Any time period for the subscription plans may be provided as desired. The subscription plans may have different features. For example, as shown on the registration, subscription and/or profile creation display 80 in FIG. 5, the subscription plan may be a “do-it-yourself” type of plan 81 or a “we do it for you” type of plan 82. As shown in FIG. 5, the contractor may review the terms of the subscription plans and/or select the desired subscription plan by touching a “Subscribe” icon 85 on the registration, subscription and/or profile creation display 80 corresponding to the desired subscription plan.

After the desired subscription plan may be selected, the contractor may enter payment information into the application 35 to complete the purchase of the desired subscription plan. The payment information may be credit card, debit card, PayPal™ (a registered trademark of eBay Inc.), ACH and/or the like.

As shown in FIG. 2, step 90 of the contractor interface 50 of the application 35 may allow the contractor to create a profile on the application 35. The contractor profile may be created by providing personal information, professional information and/or listings of services offered by the contractor. The contractor profile may also have photos and/or other images. The contractor profile may be provided to the consumer users searching for a contractor.

As shown in FIG. 2, the contractor profile may be stored in a database 100. The database 100 may be accessed by the application 35. Consumers may use the application 35 to view the contractor profiles from the database 100.

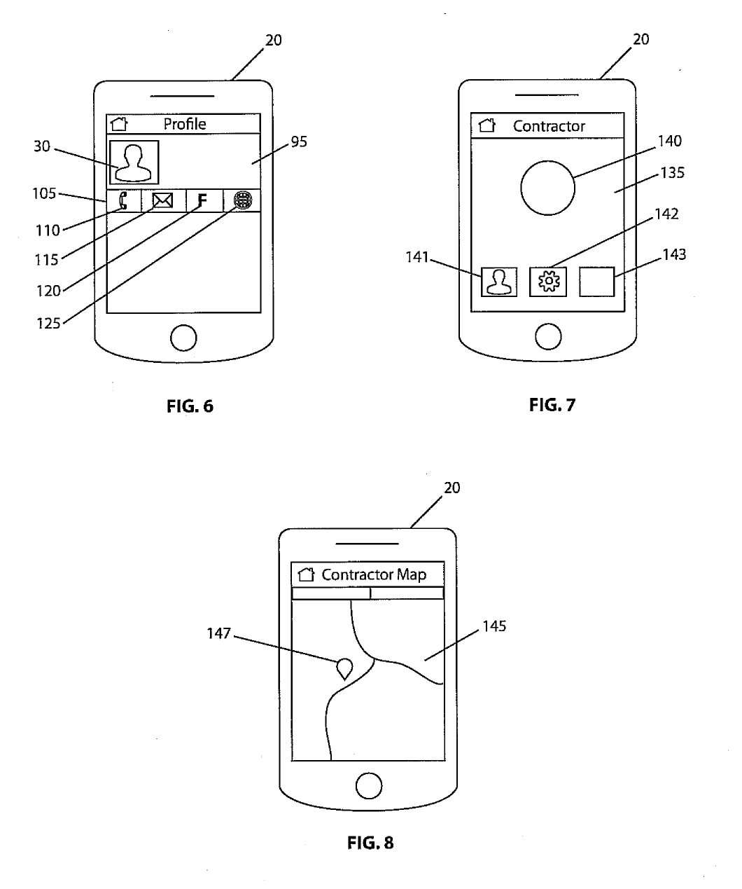

FIG. 6 illustrates a contractor profile display 95 on the screen 30 of the mobile device 20. As shown, the contractor profile display 95 may have a photo 97 of the contractor. The contractor profile display 95 may have photographs of a particular job performed by the contractor. Examples of other jobs performed with accompanying photographs may be provided. Users may view the photographs to determine the type and/or quality of work performed by the contractor.

The contractor profile display 95 may also have other features. For example, the contractor profile display 95 may have icons 105. In an embodiment, the consumer may touch the desired icon 105 on the screen 30 to select a particular feature. For example, the icons 105 may have a telephone icon 110, a text messaging icon 115, a social media link icon 120, and/or a contractor website link icon 125. The user may touch the telephone icon 110 to place a call to the contractor using the application 35. The user may also touch the text messaging icon 115 to compose and/or send a text message to the contractor using the application 35. Further, the user may touch the social media link icon 120 to visit a social media website of the contractor using the application 35. The social media link may connect the user to a Facebook® (a registered trademark of Facebook Inc.) page or a Twitter® (a registered trademark of Twitter Inc.) feed of the contractor. Finally, the user may touch the contractor website link icon 125 to visit the website of the contractor using the application 35.

As shown in FIG. 2, step 130 of the contractor interface 50 of the application 35 may allow the contractor to indicate availability and/or current location using the application 35. For example, the contractor may “punch in and/or punch out” to indicate when the contractor is available for projects. The application 35 may indicate that the contractor may be available when the contractor may have “punched in” on the application 35. The application 35 may also indicate that the contractor may be unavailable when the contractor may have “punched out” on the application 35.

Also, step 130 of the contractor interface 50 of the application 35 may allow the contractor to indicate current location using the application 35. The GPS feature of the application 35 and/or the mobile device 20 may allow a real-time location of the contractor to be displayed to the user in the application 35.

Further, the contractor interface display 65 illustrated in FIG. 4 may allow the contractor to perform certain other functions within the application 35. The contractor may manage and/or update the contractor account, the contractor profile and/or the subscription plan. Further, the contractor interface display 65 may allow the contractor to view analytics associated with the contractor account.

FIG. 7 illustrates a main contractor display 135 on the screen of the mobile device 20. After the contractor completed registration and/or payment, the application may direct the contractor to the main contractor display 135 on the screen 30 of the mobile device 20. As shown, the contractor may have several options on the main contractor display 135. The contractor may be able to activate and/or indicate availability by toggling an availability icon 140 on the main contractor display 135. The contractor may make the availability active on the application 35 which may allow users to locate the contractor on a contractor locator map 145 when making a contractor search using the application 35 as shown in FIG. 8. By “punching in” on the main contractor display 135 of the application 35, the contractor may be considered available to work and/or may be shown on the contractor locator map 145.

Further, as shown in FIG. 7, the contractor may touch a manage account icon 141 on the main contractor display 135 to update the contractor profile, manage account credentials, view details of the subscription plan, and/or view payments. Also, the contractor may touch a settings icon 142 on the main contractor display 135 to manage push notifications, sounds and/or to log out of the application 35. Moreover, the contractor may touch an analytics icon 143 on the main contractor display 135 to view analytics associated with the contractor account. The analytics may have information about the number of times the contractor may have shown in the results of a user search. The analytics may also have information about the number of views on the contractor profile on a daily, weekly or monthly basis.

After touching the desired tab on the splash display 45, the user may be directed to another screen display responsive to the selection made by the user. For example, the flowchart of FIG. 2 indicates that the user may be directed to the appropriate interface corresponding to the prior user input indicating whether the user is a consumer or a contractor. For example, after the customer may touch the tab 47 stating “I am looking for a contractor” on the splash display 45 on the screen 30 of the mobile device 20, the user may be directed to the customer interface 60.

Referring to FIG. 2, the customer interface 60 of the application 35 may have a step 150. In an embodiment, the step 150 of the customer interface 60 of the application 35 may allow the customer to perform a search for a local contractor using the application 35. The search may be a GPS search as shown in step 155 of the flowchart of FIG. 2. Alternatively, the search may be a zip code search as shown in step 160 of the flowchart of FIG. 2. The users may search for contractors by providing a zip code or zip codes. Contractors available in the selected zip code(s) may be pinned onto the contractor locator map 145.

The GPS search of step 155 may be integrated into the application 35. For example, the application 35 may utilize Google Maps™ (a registered trademark of Google, Inc.) with the GPS of the mobile device 20 to detect the location of the contractors and/or the users. The application 35 may display and/or pin the locations of the contractors on the Google Maps application and/or display the same on the screen 30. Thus, the GPS on the mobile device 20 may be used to obtain the current location of the contractor and the user. The locations may be updated on runtime. Search results may be based on the most recent location. In an embodiment, GPS coordinates may be sent to a server through web services. Search results may be retrieved from the server. Data synchronization may be performed on a nearly real-time basis.

The customer interface 60 of the application 35 of the system 10 and/or the method of the present invention may also have a step 165. In an embodiment, the step 165 of the customer interface 60 of the application 35 may allow the customer to locate the contractor on the contractor locator map 145 when making a contractor search using the application 35 as shown in FIG. 8. By “punching in” on the main contractor display 135 of the application 35, the contractor may be considered available to work and/or may be shown on the contractor locator map 145. Tapping on a pinned contractor 147 on the contractor locator map 145 may reveal a box with the picture and/or name of the contractor. The distance between the contractor and the user may also be displayed. Selecting a contractor may redirect the user to the contractor profile display 95 shown in FIG. 6.

In an embodiment, the live, real-time contractor location may be shown as a flashing light on the contractor profile display 95. The flashing light may be in a certain color to draw the attention of the user to the particular contractor. The flashing light may also be a different color to indicate that the contractor may be offering a special promotion, special pricing and/or discounts for projects in that area and/or at that time. The different color may draw additional attention and/or differentiate the contractor from other contractors. The contractor may receive more user contacts due to the flashing light and/or the different color of the flashing light.

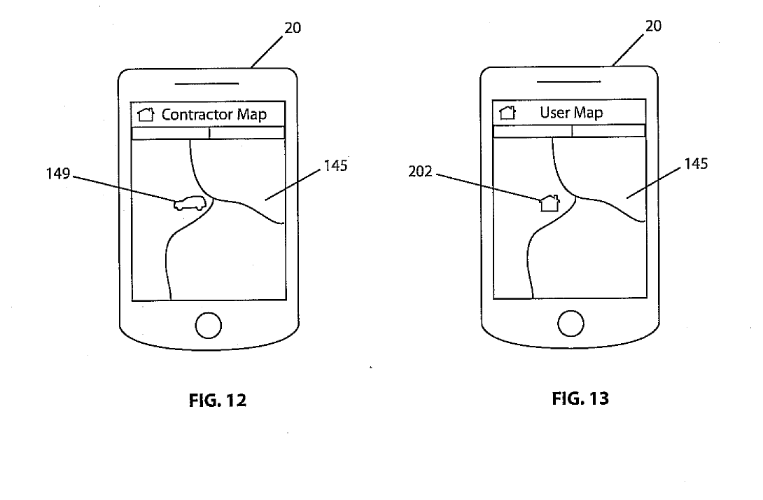

In another embodiment shown in FIG. 12, the live, real-time contractor location may be shown as an image of a van 149 on the contractor profile display 95. Typically, contractors may drive service vans. Thus, the image of the van indicating the live, real-time location of the contractor on the contractor profile display 95 may provide an intuitive reference for the user to follow and/or track the contractor. In an emergency situation, for example, when a user may be locked out of the house and/or may be waiting for a locksmith, the image of the van 149 driving on the map on the contractor profile display 95 may provide an easy way for the user to determine the live location of the approaching locksmith. Thus, the user may enjoy some peace of mind knowing that help is on the way.

In an embodiment, the contractor location may be regularly updated. The real-time movement of the contractor may be tracked directly on the screen 30. Thus, the current location of the contractor may be shown on the contractor profile display 95 as the contractor may change location.

Referring to FIG. 2, the customer interface 60 of the application 35 of the system 10 and/or the method of the present invention may also have a step 170. In an embodiment, the step 170 of the customer interface 60 of the application 35 may allow the customer to view the contractor profile display 95 using the application 35. Further, step 175 of the customer interface 60 of the application 35 of the system 10 and/or the method of the present invention may allow the user to contact the contractor.

In an embodiment, the consumer may touch the desired icon 105 on the contractor profile display 95 on the screen 30 to select a particular feature. For example, the user may touch the telephone icon 110, the text messaging icon 115, the social media link icon 120, and/or the contractor website link icon 125 as described herein.

The user may touch the telephone icon 110 to place a call to the contractor using the application 35. The user may also touch the text messaging icon 115 to place compose and/or send a text message to the contractor using the application 35. Further, the user may touch the social media link icon 120 to visit a social media website of the contractor using the application 35. The social media link may connect the user to the Facebook® (a registered trademark of Facebook Inc.) page or the Twitter® (a registered trademark of Twitter Inc.) feed of the contractor. Finally, the user may touch the contractor website link icon 125 to visit the website of the contractor using the application 35.

In an embodiment, the user may contact the contractors using a private messaging system. The user may initiate a message through the consumer interface 60 of the application 35. The private messaging system may also be provided between users. The communications between users may create more opportunities for particular contractors to be hired by the users. The messages may only be initiated by the users to the contractors. After receiving the private message, the contractor may respond to the user.

In an embodiment, an internet-based administration panel 180 may be provided to allow an administrator of the application 35 to perform certain functions. For example, the administrator may manage, maintain and/or monitor users logging onto the application 35 and/or generate user and/or contractor activity reports. The administrator may also manage contractor accounts, subscription plans and/or purchase transactions. Further, the administrator may upload and/or manage content on the application 35. Moreover, the administrator may view analytics of the application 35 and/or generate reports.

In an embodiment, the administrator display 180 may also permit the administrator to manage and/or send push notifications to the users of the application 35. For example, FIG. 10 illustrates a push notification display 185. The push notification display 185 may be sent by the administrator to the users of the application 35 and/or the contractors. The push notification display 185 may be an alert, application version update information or other information that the administrator may send to the users of the application 35. The push notification display 185 may be viewed by the users on the push notification display 185 on the screen 30 on the mobile device 20. The push notification display 185 may be dismissed by the user. The push notification display 185 may also be sent to the user to alert the user of an incoming private message from the private messaging system.

In an embodiment, the administrator display 180 may also permit the administrator to manage advertisements on the application 35. For example, FIG. 11 illustrates an advertisement display 190. The advertisement display 190 may be sent by the administrator to the users of the application 35 and/or the contractors. The advertisement display 190 may be related third-party advertisements. The administrator may manage the advertisement display 190. Alternatively, the user may sign up with Admob^{SM} (a service mark of Google, Inc.), and the application 35 may incorporate this application as a part thereof.

In an embodiment, the system 10 and/or the method of the present invention may also have a review and/or rating system. The application 35 may have the review and/or rating system to allow users to make informed decisions on which contractor to hire. The review and/or rating system may increase user engagement on the application 35. For example, the review and/or rating system may use a 5-star rating system that may be incorporated into the application 35. The rating system may be 10-star, 100-point and/or other type of rating system. The ratings and/or reviews may be posted to the contractor profile display 95 for users to review and/or determine whether to hire the contractor. The ratings and/or reviews may have photographs of a particular job performed by the contractor. Contractors may have access to the reviews and/or ratings.

In an embodiment, a two-way review system may also be provided. For example, in addition to the consumers reviewing and/or rating the contractors, a contractor may review and/or rate a subcontractor. Also, a subcontractor may review and/or rate a contractor. For example, the contractors and/or subcontractors may provide reviews and/or ratings on how the other party performed, the level of professionalism and/or skill shown and/or other relevant facts about the work relationship and/or experience. Such information may be valuable to consumers and/or contractors in selecting the best parties for the project.

In an embodiment, contractors and/or service providers may use the system 10 to locate users in need of services. Contractors and/or service providers may want to locate potential customers in a particular area. For example, the contractors and/or service providers may be working in a certain neighborhood and/or may want to continue working in that area. Thus, the contractors and/or service providers may need to locate and/or secure further projects in the neighborhood. Contractors and/or service providers may contact the customer directly to offer the services desired.

In an embodiment, the application 35 may allow the contractors and/or service providers to perform a search for a local user in need of a service using the application 35. For example, potential customers may use the system 10 to make a request for services wanted. The user may use the application 35 to indicate a request for a service. The user may also use the application 35 to indicate a current location. The user location may be provided using the GPS location and/or the zip code of the user. The application 35 of the system 10 may have a user locator map 200 as shown in FIG. 13.

The application 35 of the system 10 and/or the method of the present invention may also allow the contractors and/or service providers to locate users on the user locator map 200 when making a user search using the application 35. As shown in FIG. 13, the live, real-time user location may be illustrated as a house 202 on the user locator map 200. The distance between the contractor and the user may also be displayed.

Thus, the system 10 may be used by a consumer to locate and/or procure a local service provider. The consumer may use the system 10 for periodic services, one-time services and/or emergency services. Also, the system 10 may be used by a consumer to locate and/or procure a contractor. Further, the system 10 may be used by a contractor to locate and/or procure another contractor. In addition, the system 10 may be used by a contractor to locate and/or procure a subcontractor. Moreover, the system 10 may be used by a contractor to locate a consumer in need of a service.

Moreover, the present invention is not limited to the specific arrangement of the components illustrated in the figures. It should be understood that various changes and/or modifications to the presently preferred embodiments described herein will be apparent to those having ordinary skill in the art. Such changes and/or modifications may be made without departing from the spirit and/or scope of the present invention and without diminishing its attendant advantages. It is, therefore, intended that such changes and/or modifications be covered by the appended claims.

I claim:

1. A system for procuring desired contracting services from a contractor located within a region determined by a customer, the system comprising:
a network;
a first mobile device connected to the network wherein the first mobile device has location detection that provides a current location of the customer and further wherein the customer inputs a query for the desired contracting services on the first mobile device;
a second mobile device connected to the network wherein the second mobile device has location detection that provides a current location of the contractor in the region;
a database connected to the network wherein the database has a contractor profile having information related to the contractor and information related to contracting services offered by the contractor wherein the contractor uses the second mobile device to input the contractor profile into the database; and
an application on the first mobile device and the second mobile device wherein the application processes the query to locate the contractor in the region by using the current location of the contractor and the current location of the customer and further wherein the application provides the contractor profile from the database to the first mobile device in response to the query.

2. The system of claim 1 wherein the location detection uses a global positioning system.

3. The system of claim 1 further comprising:
a contractor interface in the application wherein the contractor inputs information using the second mobile device wherein the information is related to the contractor profile.

4. The system of claim 1 further comprising:
a customer interface in the application wherein the customer inputs information using the first mobile device wherein the information is related to the query.

5. The system of claim 1 further comprising:
an administrator interface in the application wherein an administrator provides information related to the application to users of the application wherein the information is received by the first mobile device and the second mobile device.

6. A method for procuring a desired contracting service from a contractor located within a region selected by a customer, the method comprising the steps of:
providing an application on a network wherein the application has a customer interface and a contractor interface;
connecting a first mobile device having a screen and a second mobile device having a screen to the network wherein the application is on the first mobile device and the second mobile device and further wherein the first mobile device is associated with the customer and the second mobile device is associated with the contractor;
inputting a contractor profile having information related to the contractor and information related to contracting services offered by the contractor into a database connected to the network wherein the contractor uses the contractor interface of the application on the second mobile device to input the contractor profile into the database;
submitting a request for the desired contracting service wherein the customer uses the customer interface of the application on the first mobile device to submit the request;
detecting a current location of the customer and a current location of the contractor within the region;
locating the contractor in the region using the application in response to the request by the customer on the customer interface wherein the application uses the current location of the customer and the current location of the contractor; and
providing the contractor profile of the contractor to the customer on the customer interface of the first mobile device.

7. The method of claim 6 further comprising:
performing a search for the desired contracting service using the customer interface wherein the search uses postal code information associated with the region.

8. The method of claim 6 further comprising:
performing a search for the desired contracting service using the customer interface wherein current locations of a plurality of contractors are shown on the screen of the first mobile device.

9. The method of claim 6 further comprising:
communicating between the customer and the contractor wherein the customer uses the customer interface to contact the contractor.

10. The method of claim 6 further comprising:
using the contractor interface of the application to indicate a status of the contractor wherein the status relates to availability of the contractor.

11. The method of claim 6 further comprising:
providing a customer review of the contractor using the customer interface.

12. The method of claim 6 further comprising:
providing the current location of the contractor on the screen of the first mobile device.

13. The method of claim 6 further comprising:
providing a contractor profile display on the screen of the first mobile device wherein the contractor profile display has a plurality of icons wherein the customer selects one of: a telephone icon related to a telephone number of the contractor, a text messaging icon related to a texting address of the contractor, a social media link icon related to the social media address of the contractor and a contractor website link icon related to a web address for a website of the contractor.

14. The method of claim 6 further comprising:
calculating a distance between the current location of the customer and the current location of the contractor.

15. The method of claim 6 further comprising:
redirecting the customer to a contractor profile in response to an input on the customer interface.

16. The method of claim 6 further comprising:
locating customers in response to a search by the contractor using the application on the second mobile device wherein the current location of the customers are displayed on the screen of the second mobile device.

17. The method of claim 6 further comprising:
locating a subcontractor in response to a search by the contractor using the application on the second mobile device wherein a current location of the subcontractor is displayed on the screen of the second mobile device.

18. The method of claim 6 further comprising:
managing the contractor profile wherein the contractor inputs information related to registration for the application on the second mobile device.

19. The method of claim 6 further comprising:
making payments for registration to use the application using the contractor interface.

20. The method of claim 6 further comprising:
sending information to users of the application wherein the information is at least one of: an alert, an application version update, an advertisement and administrative information.
